(19) United States
(12) Patent Application Publication
(10) Pub. No.: US 2025/0246361 A1
(43) Pub. Date: Jul. 31, 2025

(54) COIL COMPONENT

(71) Applicant: Murata Manufacturing Co., Ltd., Kyoto-fu (JP)

(72) Inventors: Akio IGARASHI, Nagaokakyo-shi (JP); Takashi YOSHIDA, Nagaokakyo-shi (JP)

(73) Assignee: Murata Manufacturing Co., Ltd., Kyoto-fu (JP)

(21) Appl. No.: 19/034,066

(22) Filed: Jan. 22, 2025

(30) Foreign Application Priority Data
Jan. 25, 2024 (JP) 2024-009114

(51) Int. Cl. H01F 27/29; H01F 27/24

(52) U.S. Cl. CPC H01F 27/29; H01F 27/24

(57) ABSTRACT

In a coil component in which a metal terminal is fixed to a core with an adhesive layer interposed therebetween, when an external force is applied, proof strength until the adhesive layer breaks is improved, and tensile strength of the metal terminal to the core is improved. In order to reduce stress remaining in the adhesive layer at the time of curing the adhesive, the adhesive layer for fixing the metal terminal to the core is configured to include the adhesive and bubbles. A size of the bubbles is preferably 300 μm or less in terms of an equivalent circle diameter, and an area ratio of the bubbles is preferably 2.9% or more and 27% or less (i.e., from 2.9% to 27%) in a section of the adhesive layer.

### CROSS-REFERENCE TO RELATED APPLICATION

This application claims benefit of priority to Japanese Patent Application No. 2024-009114, filed Jan. 25, 2024, the entire content of which is incorporated herein by reference.

### BACKGROUND

### Technical Field

The present disclosure relates to a coil component, and particularly relates to improvement of an adhesive layer for fixing a metal terminal to a core in a coil component including the core holding a coil conductor and the metal terminal connected to the coil conductor.

### Background Art

As a technique of interest for the present disclosure, for example, there is a technique described in Japanese Patent Application Laid-Open No. 2021-039961. Japanese Patent Application Laid-Open No. 2021-039961 describes a coil component including: a drum-shaped core including a winding core and flanges respectively provided at ends opposite to each other in an axial direction of the winding core; a wire as a coil conductor wound around the winding core; and a metal terminal made of a metal plate connected to the wire, in which the metal terminal is fixed to the flange of the core with an adhesive layer containing an adhesive interposed therebetween.

As described above, a structure including the metal terminal as a terminal for connection with an outside is adopted in, for example, a common mode choke coil for an automobile. In the common mode choke coil for the automobile, a crack is likely to occur in a solder for connection to a printed circuit board due to a heat cycle under a use environment, however, when the metal terminal made of the metal plate is adopted as a terminal, occurrence of the crack in the solder can be suppressed to some extent by deformation of the metal terminal itself.

### SUMMARY

In the coil component described in Japanese Patent Application Laid-Open No. 2021-039961, when the metal terminal is fixed to the core with the adhesive layer interposed therebetween, stress remains in the adhesive layer during curing of the adhesive. In particular, the thicker the adhesive layer, the greater this residual stress. The residual stress causes a decrease in proof stress until the adhesive layer is broken when an external force is applied.

Therefore, the present disclosure provides a coil component to reduce stress remaining in the adhesive layer that joins the metal terminal to the core in the coil component.

The present disclosure is directed to a coil component including a coil conductor; a core that holds the coil conductor; a metal terminal connected to the coil conductor; and an adhesive layer containing an adhesive for fixing the metal terminal to the core. In order to address technical problems described above, the present disclosure is characterized in that the adhesive layer contains an adhesive and bubbles.

According to the present disclosure, since the adhesive layer contains bubbles, bubbles that are gas have greater deformability than the adhesive before curing. As a result, the bubbles expand in response to shrinkage of the adhesive generated during curing, and the adhesive layer as a cured product in which the residual stress of the adhesive portion is reduced can be obtained. Therefore, since the residual stress of the adhesive portion in the adhesive layer can be reduced, the adhesive layer can be a cured product having high strength, and thus tensile strength of the metal terminal to the core can be improved.

### BRIEF DESCRIPTION OF THE DRAWINGS

FIGS. 1A and 1B are perspective views showing an appearance of a coil component according to an embodiment of the present disclosure, in which FIG. 1A is a view seen from a relatively upper side, and FIG. 1B is a view seen from a relatively lower side;

FIG. 2 is an enlarged sectional view taken along line II-II in FIGS. 1A and 1B, showing a portion where a metal terminal is attached to a flange in the coil component shown in FIGS. 1A and 1B;

FIG. 3 is a view showing sectional polished photographs of adhesive layers in four states in which area ratios of bubbles are different; and

FIG. 4 is a view showing tensile strength of a metal terminal to a core in four states in which the area ratios of bubbles are different shown in FIG. 3.

### DETAILED DESCRIPTION

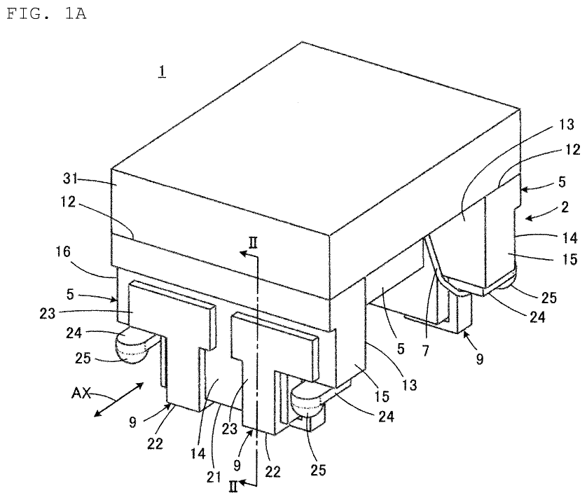

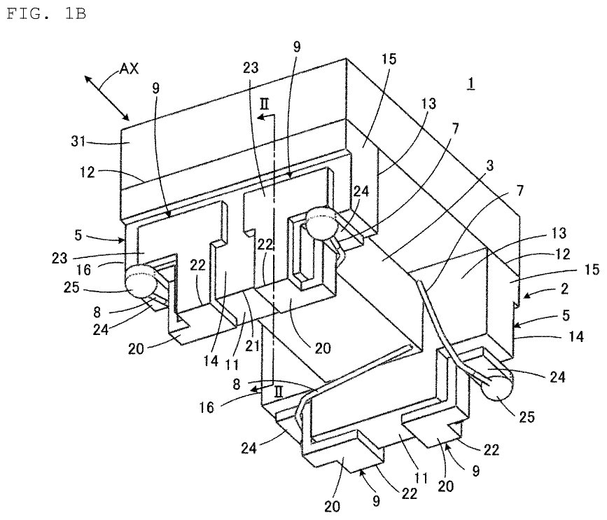

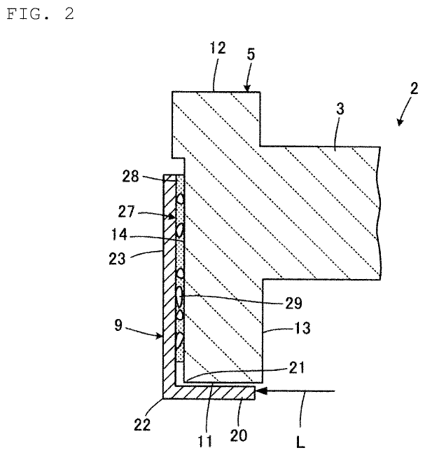

A coil component 1 according to an embodiment of the present disclosure will be described with reference to FIGS. 1A, 1B, and 2. The coil component 1 shown in FIGS. 1A and 1B constitutes, for example, a common mode choke coil.

A core 2 included in the coil component 1 has a drum shape, and includes a winding core 3 and flanges 5 respectively provided at ends opposite to each other in an axial direction AX of the winding core 3. The core 2 preferably includes ferrite. Note that, the core 2 may include a non-conductive material other than ferrite, for example, a non-magnetic body such as alumina, or a resin containing ferrite powder or metal magnetic powder.

Two wires 7 and 8 as coil conductors are wound around the winding core 3. In FIGS. 1A and 1B, illustration of main parts of the wires 7 and 8 is omitted.

Each of ends of the wires 7 and 8 is connected to a metal terminal 9. As shown in FIGS. 1A and 1B, the coil component 1 includes four metal terminals 9. The four metal terminals 9 have the same or symmetrical shape. More specifically, two metal terminals 9 having symmetrical shapes are arranged side by side in a width direction at one flange 5, and similarly, two metal terminals 9 having symmetrical shapes are arranged side by side in the width direction at the other flange 5.

The winding core 3 included in the core 2 has, for example, a quadrangular prism shape having a quadrangular sectional shape. Note that the sectional shape of the winding core 3 may be a polygon such as a hexagon, a circle, an ellipse, or a combination thereof in addition to a quadrangle.

Each of the flanges 5 included in the core 2 has a bottom surface 11 extending parallel to the axial direction AX and facing a mounting substrate side at the time of mounting, and a top surface 12 facing in a direction opposite to the bottom surface 11. Each of the flanges 5 also has an inner end surface 13, which is a surface rising from the bottom surface 11, extends in a direction orthogonal or substantially orthogonal to the mounting substrate, and positions an end of the winding core 3, an outer end surface 14 facing in a direction opposite to the inner end surface 13, and a first side surface 15 and a second side surface 16 which connect the inner end surface 13 and the outer end surface 14.

The metal terminal 9 is manufactured by processing a metal plate including, for example, a copper-based alloy such as phosphor bronze or tough pitch copper. Tin plating is preferably applied to the metal plate as a material of the metal terminal 9. The metal plate has a thickness of, for example, 0.10 mm or more and 0.15 mm or less (i.e., from 0.10 mm to 0.15 mm).

Each of the metal terminals 9 has a base portion 20 extending along the bottom surface 11 of the flange 5, and a rising portion 23 connected from the base portion 20 via a bent portion 22 covering a ridgeline 21 where the bottom surface 11 and the outer end surface 14 of the flange 5 intersect, and extending along the outer end surface 14 of the flange 5. Further, a connection piece 24 extending from the base portion 20 is formed in each of the metal terminals 9.

Each of the ends of the wires 7 and 8 is connected to the connection piece 24 of the metal terminal 9. For this connection, for example, laser welding is applied. FIGS. 1A and 1B show a welded lump 25 formed by laser welding and rising in a hemispherical shape. Besides the laser welding, each of the ends of the wires 7 and 8 may be connected to the connection piece 24 of the metal terminal 9 by thermocompression bonding, or may be connected by other methods.

The wires 7 and 8 usually have a circular section, and include a linear center conductor and an insulating film including an electrically insulating resin covering a peripheral surface of the central conductor. The center conductor has a diameter of, for example, 28 μm or more and 50 μm or less (i.e., from 28 μm to 50 μm). Further, the insulating film has a thickness of, for example, 3 μm or more and 6 μm or less (i.e., from 3 μm to 6 μm). The center conductor includes, for example, a highly conductive metal such as copper, silver, or gold. The insulating film includes, for example, polyurethane, polyamideimide, polyester, or polyimide.

Although not shown in FIGS. 1A and 1B, the two wires 7 and 8 are spirally wound around the winding core 3 in the same direction. More specifically, the two wires 7 and 8 may be wound in two layers such that one of the wires 7 and 8 is wound on the an inner layer side and the other is wound on an outer layer side, or may be wound in a bifilar winding in a state where turns are alternately arranged in the axial direction of the winding core 3 and arranged in the same direction.

A portion where the metal terminal 9 is attached to the flange 5 is well shown in FIG. 2. The metal terminal 9 is joined to the flange 5 with an adhesive layer 27 interposed therebetween. More specifically, the metal terminal 9 is fixed to the flange 5 with the adhesive layer 27 interposed therebetween at the outer end surface 14 of the flange 5.

An adhesive constituting the adhesive layer 27 is generally an epoxy resin containing a main agent and a curing agent. For example, a one-component epoxy resin containing bisphenol A or F as the main agent and amine or dicyandiamide as the curing agent is used. The adhesive may further contain carbon as a colorant, an inorganic solid such as silica as a filler, or an appropriate additive other than the above.

Adhesives are known to shrink in thermal curing. Shrinkage in thermal curing causes an increase in residual stress inside the adhesive layer 27, and when an external force is applied, proof stress until the adhesive layer is broken decreases. Therefore, the residual stress inside the adhesive layer 27 is preferably small.

In order to reduce the residual stress inside the adhesive layer 27, as schematically shown in FIG. 2, the adhesive layer 27 contains bubbles 29 in addition to an adhesive 28. A state in which the adhesive layer 27 contains the adhesive 28 and the bubbles 29 as described above is obtained, for example, by stirring while injecting gas into the adhesive 28 in a liquid state before curing. As a stirring method, for example, a planetary mixer is used. As the gas to be injected, that is, the gas to be filled in the bubbles 29, for example, an inert gas such as nitrogen or argon is preferable, or air which is mainly a mixture of nitrogen, oxygen, argon and carbon dioxide may be used. The air mentioned here is a gas constituting the earth's atmosphere. The inert gas such as nitrogen or argon has an advantage that oxidation of the adhesive can be suppressed. In addition, there is an advantage that air is inexpensive.

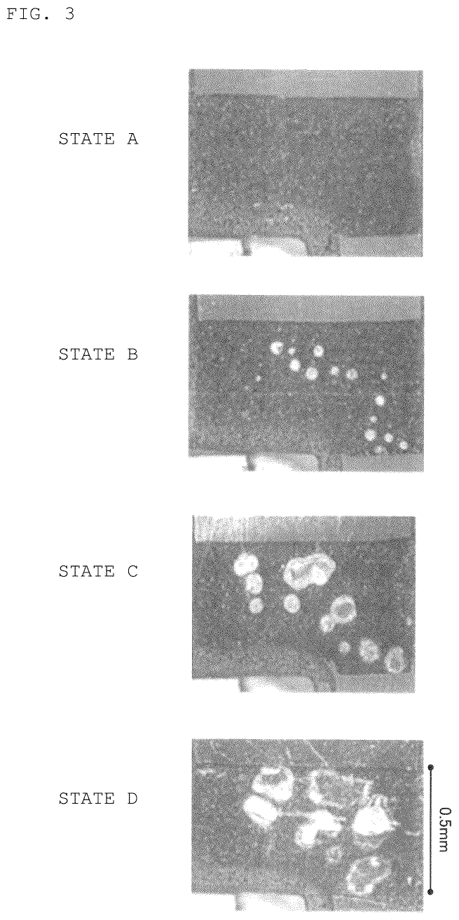

The bubbles 29 preferably include a bubble having a flat shape such as a crushed sphere. In particular, it is more preferable that a long diameter direction that gives the flat shape of the bubbles 29 is directed in a direction perpendicular to a thickness direction of the adhesive layer 27. In FIG. 3 described later, the bubbles 29 contained in the adhesive layer 27 are shown as whitish images, but since FIG. 3 shows sectional polished photographs in the direction perpendicular to the thickness direction, it is difficult to visually recognize the flat shape of the bubbles 29 in the photographs.

A size of the bubbles 29 on a section appearing by polishing the adhesive layer 27 in parallel with an adhesive surface is preferably 300 μm or less in terms of an equivalent circle diameter. When the size exceeds 300 μm, a degree of decrease in adhesive area between the adhesive layer 27 and each of the metal terminal 9 and the core 2 in contact with the adhesive layer increases, and there is a concern that the adhesive strength may decrease.

An area ratio of the bubbles 29 is preferably 2.9% or more and 27% or less (i.e., from 2.9% to 27%) on the section appearing by polishing the adhesive layer 27 in parallel with the adhesive surface. This is because when the area ratio of the bubbles 29 is less than 2.9%, since an occupancy ratio of the bubbles 29 is too low, the residual stress may not be fully released. On the other hand, when the area ratio of the bubbles 29 exceeds 27%, this is because an amount of expansion of the bubbles 29 due to heat in a curing process of the adhesive 28 cannot be ignored, it is difficult to control the air bubbles 29, and it is difficult to manufacture the adhesive layer 27 with good reproducibility.

As shown in FIGS. 1A and 1B, the coil component 1 may further include a top plate 31 bridged between top surfaces 12 of the two flanges 5. As in the case of the core 2, the top plate 31 preferably includes ferrite. Further, the top plate 31 may include a non-conductive material other than ferrite, for example, a non-magnetic body such as alumina, or a resin containing ferrite powder or metal magnetic powder.

The top plate 31 is bonded to the top surfaces 12 of the two flanges 5 by the adhesive (not shown). Thus, the top plate 31 can form a closed magnetic circuit in cooperation with the core 2. As the adhesive, for example, an adhesive containing an epoxy resin or an adhesive containing a silica filler in addition to this is used.

Next, an experimental example performed to confirm effects of the present disclosure will be described.

As the adhesive, the one-component epoxy resin containing bisphenol A as the main agent and amine as the curing agent was used. In the liquid state before curing of the adhesive, the bubbles were contained in the adhesive by stirring with a planetary mixer while injecting nitrogen gas. Then, a sample having a structure as shown in FIG. 2 in which the adhesive layer containing the bubbles and the adhesive was formed was obtained. Note that each of adhesive layers in samples had an adhesive surface area of 4.0×10^{5 μ}m² and a thickness of 30 μm.

Here, samples having different bubble area ratios, bubble diameters, and tensile strengths of the adhesive layers to be formed by the adhesive were obtained by changing stirring conditions described above for obtaining an adhesive containing bubbles.

Note that the bubble area ratio and the bubble diameter are respectively the area ratio and the diameter of the bubbles on the section appearing by polishing the adhesive layer in parallel with the adhesive surface, however, since the samples subjected to measurement of the bubble area ratio and the bubble diameter are in a state of being treated in a state where a section of the adhesive layer is exposed, the samples themselves cannot be subjected to measurement of the tensile strength. Therefore, in this experimental example, adhesives treated under predetermined stirring conditions were prepared, and a sample to be subjected to the measurement of the bubble area ratio and the bubble diameter and a sample to be subjected to the measurement of the tensile strength were selected from among the adhesives. That is, since the sample to be subjected to the measurement of the bubble area ratio and the bubble diameter and the sample to be subjected to the measurement of the tensile strength are adhesives treated under common stirring conditions, it is estimated that the bubble area ratio, the bubble diameter, and the tensile strength are substantially the same.

Table 1 shows the “bubble area ratio”, the “bubble diameter”, and the “tensile strength” determined by measurement. The number of samples for each of the “bubble area ratio”, the “bubble diameter”, and the “tensile strength” is 10, and an average thereof is shown.

FIG. 3 shows sectional polished photographs in a direction parallel to the adhesive surface, that is, the direction perpendicular to the thickness direction of the adhesive layer. In FIG. 3, the bubbles contained in the adhesive layer are shown as the whitish images, and a dark region around the bubbles shows the adhesive. “STATE A”, “STATE B”, “STATE C”, and “STATE D” in FIG. 3 respectively correspond to “State A”, “State B”, “State C”, and “State D” in Table 1.

As shown in Table 1, the “bubble area ratio” was 0% for the adhesive layer in the “state A”, 2.9% for the adhesive layer in the “state B”, 14% for the adhesive layer in the “state C”, and 27% for the adhesive layer in the “state D”.

The “bubble area ratio” is a ratio of an area occupied by bubbles appearing in a section in a direction perpendicular to the thickness direction at the center in the thickness direction of the adhesive layer with respect to an area of the adhesive surface of the adhesive layer, and was calculated by binarizing luminance values of the bubbles by image processing software on an observation surface. Note that at the time of shooting a sectional image for determining the “bubble area ratio”, bubbles having an area that cannot be identified as the bubble were not considered as the bubble. More specifically, bubbles having a diameter less than 1% of the equivalent circle diameter of the adhesive surface of the adhesive layer were not considered as the bubble. In the case of this experimental example, since the area of the adhesive surface of the adhesive layer is 4.0×10⁵ μm², the equivalent circle diameter is 710 μm, and 1% thereof is 7.1 μm. Therefore, bubbles having a diameter of less than 7.1 μm were not considered as bubbles for determining the “bubble area ratio”.

The “bubble diameter” was obtained by calculating an average of equivalent circle diameters of bubbles having a diameter of 7.1 μm or more and appearing in the section in the direction perpendicular to the thickness direction at the center in the thickness direction of the adhesive layer, which was the same section as a section for which the “bubble area ratio” was calculated. Similarly, in the case of determining the “bubble diameter”, the bubbles having a diameter of less than 7.1 μm were not considered as bubbles for determining the “bubble diameter”.

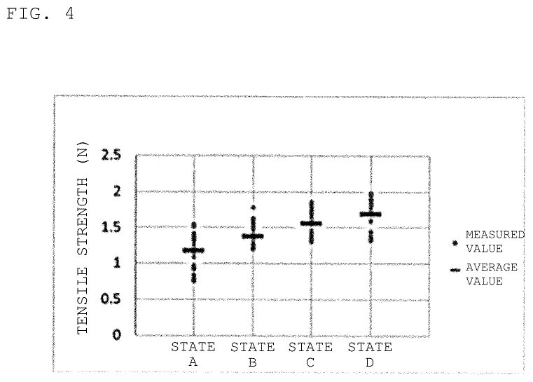

In addition, the tensile strength of the metal terminal to the core in each of the states A to D was measured. The results are shown in “Tensile strength” in Table 1 and FIG. 4. FIG. 4 shows an average value and a distribution state of the tensile strength for 10 samples. When described with reference to FIG. 2, the tensile strength indicates a force at a time point when a force in a direction indicated by an arrow L is applied to the metal terminal 9 while the core 2 is fixed by an appropriate holder (not shown), the force is gradually increased, and the metal terminal 9 can no longer be held by the core 2. Note that a phenomenon that the metal terminal 9 can no longer be held by the core 2 can occur either due to breakage within a range of the thickness of the adhesive layer 27 itself (cohesive failure) or due to separation at an interface between the adhesive layer 27 and the core 2 or the metal terminal 9 (interfacial failure), but in this experimental example, a mixed failure of both types occurred.

TABLE 1

| | Bubble area ratio | Bubble diameter | | Tensile strength |
|---|---|---|---|---|
| | (average value) | (average value) | | (average value) |
| State A | 0% | 0 | μm | 1.18 N |
| State B | 2.9% | 26.4 | μm | 1.38 N |
| State C | 14% | 81.3 | μm | 1.57 N |
| State D | 27% | 136 | μm | 1.70 N |

As can be seen from Table 1 and FIG. 4, the adhesive layers in the state B, the state C, and the state D containing the bubbles have improved tensile strength compared to the adhesive layer in the state A not containing the bubbles. This is because the residual stress was smaller in the adhesive layers in the state B, the state C, and the state D than in the adhesive layer in the state A.

In addition, when comparing the state B, the state C, and the state D including the bubbles, as the “bubble area ratio” increases, the “bubble diameter” increases, and the “tensile strength” increases. Note that it is not the case that the “bubble area ratio” is preferably larger without limit, but the “bubble area ratio” is preferably 27% or less as described later.

From data shown in Table 1, it can be read that the size of the bubbles is preferably 300 μm or less in terms of the equivalent circle diameter, and the bubble area ratio is preferably 2.9% or more and 27% or less (i.e., from 2.9% to 27%).

Although the coil component according to the present disclosure has been described above based on the embodiment related to the common mode choke coil, this embodiment is illustrative, and various other modifications can be implemented. Therefore, the number of wires included in the coil component, a winding direction of the wires, the number of metal terminals, and the like can be changed according to a function of the coil component.

Further, in the above-described embodiment, the coil component includes the wires 7 and 8 as the coil conductors, but the present disclosure can also be applied to a coil component including a coil conductor including a conductor film instead of the wires.

Further, in the embodiment described above, the coil component includes as the core the drum-shaped core including the winding core 3 and the flanges 5 respectively provided at the ends opposite to each other in the axial direction of the winding core 3, but the present disclosure can also be applied to a coil component including a core having another shape such as a simple plate shape, and further a coil component having a laminated structure.

In addition, in the above-described embodiment, the adhesive containing the epoxy resin has been exemplified as the adhesive for fixing the metal terminal 9 to the core 2, but the present disclosure can be similarly applied to an adhesive having another composition.

In addition, each embodiment described in the present specification is illustrative, and partial replacement or combination of configurations is possible between different embodiments.

The embodiments of the present disclosure include the following.
<1> A coil component including a coil conductor; a core that holds the coil conductor; a metal terminal connected to the coil conductor; and an adhesive layer for fixing the metal terminal to the core. the adhesive layer contains an adhesive and bubbles.
<2> The coil component according to <1>, in which the bubbles are filled with at least one gas selected from nitrogen, argon, and air.
<3> The coil component according to <1> or <2>, in which the bubbles include a bubble having a flat shape.
<4> The coil component according to any one of <1> to <3>, in which an average of sizes of the bubbles is 300 μm or less in terms of an equivalent circle diameter.
<5> The coil component according to any one of <1> to <4>, in which an area ratio of the bubbles is 2.9% or more and 27% or less (i.e., from 2.9% to 27%) in a section of the adhesive layer.
<6> The coil component according to any one of <1> to <5>, in which the core includes a winding core and flanges respectively provided at ends opposite to each other in an axial direction of the winding core, the coil conductor includes a wire wound around the winding core, the wire is connected to the metal terminal, and the metal terminal is joined to each of the flanges with the adhesive layer interposed therebetween.
<7> The coil component according to <6>, in which each of the flanges has an inner end surface on which an end of the winding core is positioned and an outer end surface facing in a direction opposite to the inner end surface, and the metal terminal is joined to each of the flanges with the adhesive layer interposed therebetween on the outer end surface of each of the flanges.

What is claimed is:

1. A coil component comprising:
a coil conductor;
a core that holds the coil conductor;
a metal terminal connected to the coil conductor; and
an adhesive layer that fixes the metal terminal to the core,
wherein the adhesive layer includes an adhesive and bubbles.

2. The coil component according to claim 1, wherein
the bubbles are filled with at least one gas selected from nitrogen, argon, and air.

3. The coil component according to claim 1, wherein
the bubbles include a bubble having a flat shape.

4. The coil component according to claim 1, wherein
an average of sizes of the bubbles is 300 μm or less in terms of an equivalent circle diameter.

5. The coil component according to claim 1, wherein
an area ratio of the bubbles is from 2.9% to 27% in a section of the adhesive layer.

6. The coil component according to claim 1, wherein
the core includes a winding core and flanges respectively provided at ends opposite to each other in an axial direction of the winding core,
the coil conductor includes a wire wound around the winding core,
the wire is connected to the metal terminal, and
the metal terminal is joined to each of the flanges with the adhesive layer interposed therebetween.

7. The coil component according to claim 6, wherein
each of the flanges has an inner end surface on which an end of the winding core is located and an outer end surface facing in a direction opposite to the inner end surface, and
the metal terminal is joined to each of the flanges with the adhesive layer interposed therebetween on the outer end surface of each of the flanges.
